(19) United States
(12) Patent Application Publication
(10) Pub. No.: US 2025/0338801 A1
(43) Pub. Date: Nov. 6, 2025

(54) SYSTEMS AND METHODS FOR INSECT CONTROL

(71) Applicant: TerrAmor, Inc., Corvallis, OR (US)

(72) Inventors: Vaughn Walton, Corvallis, OR (US); Gabriella Tait, Corvallis, OR (US)

(21) Appl. No.: 18/866,311

(22) PCT Filed: May 25, 2023
(86) PCT No.: PCT/US2023/023552

§ 371 Date: Nov. 15, 2024

Related U.S. Application Data
(60) Provisional application No. 63/348,826, filed on Jun. 3, 2022.

(51) Int. Cl. A01G 13/10; A01G 25/02; A01M 1/20

(52) U.S. Cl. CPC A01G 13/10; A01G 25/02; A01M 1/20; A01M 2200/012

(57) ABSTRACT

Dispensers according to the inventive subject matter have a set of one or more functional attributes. The dispenser may include a receptacle area for supporting a substrate. The dispenser may allow for insect ingress. The dispenser may allow for easy wetting of the substrate on the receptacle, or to allow for release of active agents, while supporting the substrate above standing water. Similarly, the dispenser may allow for easy coupling to irrigation lines that provide the wetting or for coupling to other objects to secure a dispenser in place. The dispenser may allow for easy addition of substrates onto the receptacle to replenish used substrates. Methods of deploying insect control compositions using dispensers are also contemplated.

### RELATED APPLICATIONS

This application claims benefit of and priority from U.S. Provisional Patent Application No. 63/348,826, filed Jun. 3, 2022, which is hereby incorporated by reference in its entirety as if fully set forth herein, for all purposes.

### BACKGROUND

The inventive subject matter generally relates to systems and methods for controlling insect population size. In particular aspects, it relates to systems and methods that use behavioral arrestants that divert insect oviposition to target sites with attributes that disrupt viability of eggs or larvae, pupae, or adults. The inventive subject is particularly suited to diverting fruit-infesting insects like fruit flies from ovipositioning on their natural fruit or plant target to ovipositioning on an alternative substrate that detrimentally affects egg or larvae viability. In certain embodiments, a dispenser is configured to support a substrate having insect-attracting volatile agents, and to allow for emission of the volatiles, and insect ingress into the dispenser.

Although the principles of the inventive subject may apply to a variety of insects and plants, the inventive principles primarily will be illustrated with respect to the fruit fly, Drosophila suzukii, spotted-wing drosophila (“SWD”).

Across the US and other countries, SWD has caused substantial income loss for soft fruit growers and increased insecticide applications. Heavy reliance on insecticides is not sustainable within the context of Integrated Pest Management program (IPM). New non-toxic strategies are necessary to alleviate the disadvantages and non-target impacts of conventional insecticides and to provide affordable alternatives to farmers.

SWD possesses a long-serrated ovipositor that enables the pest to lay its egg inside of fresh fruit, creating challenging management strategies. Hatched larvae burrow on fresh fruit rendering the fruit unmarketable. For instance, when SWD first became established in the US, the total annual revenue losses for the West Coast berry and cherry industries were estimated at over $500 million. The high dispersal potential, the ability to survive/adapt in harsh environmental conditions, and the variety of hosts, make SWD an ongoing threat to the soft skin and stone fruit industry.

The intensive use of chemical controls increases costs and poses a tremendous risk to non-target organisms such as pollinators, natural enemies, and humans. Moreover, frequent insecticide application may cause insects to develop resistance. For these reasons, developing new sustainable insecticide alternatives is imperative for a return to IPM, and for the long-term success of the fruit producers.

Alternatives or supplements to insecticide include cultural methods like cladding, irrigation, netting, mulching, pruning, monitoring, and mass trapping. Each method may reduce SWD infestations, and yet they might not be enough to significantly reduce the damage.

Bacterial and yeast derived lures or fermentation products are also used, in addition to insecticides, to minimize SWD damage in soft skinned fruits. Additives like sugar, vinegar, wine, and flour can improve the efficiency of traps; however, such baited traps could also attract more adults into the field causing more fruit infestation, and selectivity to SWD is low.

A behavioral control system able to disrupt oviposition of female SWD was created in 2017. This behavioral control system uses non-toxic food-grade gum (“FGG”), which is an extremely competitive substrate compared to soft skinned fruits like blueberries, cherries, strawberries, etc. The specific mixture of ingredients in FGG offers an alternative feeding and reproductive site for both males and females. Possessing positive tactile and odorant cues, FGG works as a behavioral arrestant for foraging adult SWD. In addition to plant-based cues, the volatile emission profile of the FGG also contains semiochemicals found in secretions released by females during oviposition. It is indicated that female SWD use fruit volatiles to locate their hosts. The semiochemicals in FGG have been shown to be instrumental in causing additional oviposition by other females.

Trials conducted on strawberry, blackberry, raspberry, blueberry, cherry, and wine-grape crops have shown that FGG has the potential for managing SWD infestations. The studies suggest that point sources of FGG are highly competitive with ripening fruits in reducing SWD oviposition in larger open-field commercial crops.

Multiple types of volatile release point-sources have been used in mating disruption for various insects. Point sources include polyethylene tubes, incorporation of active volatiles into plastic wafers, or placement in hollow fibers, and spray formulations. Despite their differences in materials and structures, these systems have the same goal: the efficient release of a specific quantity of active volatiles over a prolonged period.

Effective behavioral control of SWD is highly dependent on the active volatiles involved and their appropriate delivery. The right release device becomes essential when attempting to implement behavioral pest management techniques. Control capabilities can suffer if the release rate is inconsistent over time. If, for example, the active volatile is released at a non-constant or insufficient rate, then the concentration of the volatile plume might be inefficient from a behavioral perspective and its control capabilities could suffer. The activity of volatiles is biologically complex; their dispersion in the environment requires constant-release devices to ensure a consistent, controlled release of the active volatile compounds over a prolonged time.

The effectiveness of the FGG is directly related to its water content. Dehydration of the matrix gradually reduces the release of active volatiles, and complete desiccation inactivates the FGG. It has been demonstrated that FGG spread on a microfiber cloth and systematically wetted lasted for more than 21 days and provided a radius of attractance of 7 meters (Rossi-Stacconi et al. 2020). Despite such promising results, microfiber as delivery device had multiple disadvantages: it is a synthetic product that cannot be registered as an organic pesticide; its application requires connectivity to the irrigation system, which is not easy; requires hours of labor to manage; and it is not biodegradable.

Accordingly, current systems using FGG need improvement and optimization. For example, there is a need for dispensers that hold or otherwise present the FGG substrates so that the FGG is detectable and accessible by SWD. There is a need for dispensers that allow for adequate hydration of FGG. There is a need for such systems to have a constant or managed release rate of volatiles. There is also a need for the FGG to have a reasonably long field life so that it does not need to be frequently replenished. Similarly, there is a need for dispenser that allow for easy replenishment of expended substrates. There is also a need for more optimized placement and integration of dispenser in crops and with existing farming infrastructure like irrigation lines.

There is also a need for dispensing systems and substrates that are selectively targeted to SWD or another selected insect species.

### SUMMARY

The inventive subject matter overcomes the disadvantages of the prior art and addresses the aforementioned needs by providing improved dispenser systems and methods, as disclosed in this patent specification.

Dispensers according to the inventive subject matter have a set of one or more functional attributes. The dispenser may include a receptacle area for supporting a substrate. The dispenser may allow for insect ingress. The dispenser may allow for easy wetting of the substrate on the receptacle to turn it into a gum, or to allow for release of active agents, while supporting the substrate above standing water. Similarly, the dispenser may allow for easy coupling to irrigation lines can wet substrate in the dispenser or for easy coupling to objects to secure a dispenser in place and create a field arrangement. The dispenser may allow for easy addition of substrates onto the receptacle to replenish used substrates. Methods of deploying insect control compositions using dispensers are also contemplated.

In one possible embodiment, the inventive subject matter is directed to a dispenser for supporting a substrate comprising an insect control composition. The dispenser includes one or more sidewalls extending upwardly from a bottom wall of the dispenser, the sidewalls and bottom wall being configured with a plurality of apertures. A receptacle is disposed in a space defined by the sidewalls and bottom wall for supporting the substrate. At least one aperture is disposed in a sidewall that is sized and shaped to receive a section of an irrigation line so that one or more apertures in the line direct water onto the receptacle disposed on the receptacle. The irrigation line aperture or apertures having an opening size to accommodate irrigation line having a diameter of from 2 cm-10 cm. At least one aperture, other than the irrigation line apertures, is disposed in a sidewall, bottom wall, or in a lid for the dispenser and is sized and shaped to allow ingress of a target insect. And wherein at least one aperture disposed in a sidewall or bottom wall is a drainage aperture that is positioned to drain water so that water does not stand at or above the level of the receptacle. And each of the dispenser height, width, and depth dimensions may be between 1 cm to 30 cm.

In the foregoing or any other embodiment, the entire receptacle may be at a bottom portion of the dispenser and surrounded by upwardly extending walls.

In the foregoing or any other embodiment, the dispenser may further include means for coupling a dispenser to an irrigation line, plant, or other object.

In the foregoing or any other embodiment, the coupling means may include a removable or hingeable lid that is securable to the dispenser so that an irrigation line disposed in an aperture is captured between the aperture's defining walls and the lid.

In the foregoing or any other embodiment, opposing apertures may be disposed in the dispenser and arranged and configured to receive a section of irrigation line.

In the foregoing or any other embodiment, one or more apertures disposed on the bottom portion of a dispenser may be configured to provide drainage and insect ingress, with at least one aperture having an area that extends both above and below the substrate-receiving surface of the receptacle and/or (2) a plurality of apertures being arranged on a sidewall(s) so that there are apertures both above and below the substrate-receiving surface of the receptacle.

In the foregoing or any other embodiment, the dispenser and/or lid may include open areas other than the irrigation line aperture or apertures through which a substrate may be passed to the receptacle's substrate-receiving surface.

In the foregoing or any other embodiment, a substrate may be included with the dispenser. The substrate may be a composition that is an active agent for management or control of the target insect type. The substrate may be one or more tablets packaged into or with the dispenser.

In the foregoing or any other embodiment, the substrate may be a food grade gum (FGG).

The substrate may include a cherry-derived component in an amount of 0.1 wt % to about 99 wt %, 0.5 wt % to 90 wt %, 10 wt % to 90 wt %, %, 40 wt % to 80 wt %, or 50 wt % to 70 wt % on dry weight basis.

The substrate may include thiamine in an amount of 0.001 wt % to 99 wt %, 0.1 wt % to 50 wt %, or 0.5 wt % to 10 wt % on dry weight basis.

The substrate may include a humectant comprising hyaluronic acid, alginic acid, collagen, calcium chloride, egg white, egg yolk, gelatin, glycerol, triacetin, glycerol acetates, lecithin, pyrrolidone carbonic acid, sorbitol, xylitol, mannitol, maltitol, honey, caramelized sucrose, and/or propylene glycol, sodium lactate, glycerin betaine, trehalose, sodium stearoyl lactate, or a combination thereof.

The substrate may include one or more components selected from collagen, beta-cyclodextrin, carrageenan, agar, calcium acetate, and calcium propionate.

The substrate may include cellulose pulp, thiamine, hyaluronic acid, collagen, beta-cyclodextrin, carrageenan, agar, calcium acetate, and calcium propionate.

The substrate may include dried D. suzukii insect powder.

The substrate may include citric acid.

In the foregoing or any other embodiment, the substrate may be an ovipositional site that is a substitute for the target insect's natural ovipositional site.

In another possible embodiment, the inventive subject matter is directed to a dispenser system for pest management. The dispenser includes one or more sidewalls extending upwardly from a bottom wall of the dispenser. At least one aperture is disposed in a wall that is sized and shaped to allow ingress of a target insect type. A receptacle for supporting the substrate is disposed in a space defined by the sidewalls and bottom wall. The substrate may be composition that is an active agent for management or control of the target insect type. Each of the dispenser height, width, and depth dimensions may be between 1 cm to 30 cm.

In the foregoing or any other embodiment, the dispenser may include at least one aperture that is a drainage aperture that is positioned to drain water so that water does not stand at or above the level of the receptacle.

The dispenser of any claim herein wherein the substrate comprises an ovipositional site that is a substitute for the insect's natural ovipositional site.

In the foregoing or any other embodiment, the substrate may be an egg desiccator or other disruptor for disrupting the viability of eggs, larvae, or pupae of a selected insect species.

In the foregoing or any other embodiment, the dispenser system may include an attractant for a fruit fly species, such as SWD.

In the foregoing or any other embodiment, the inventive subject matter may be directed to a method of insect control comprising providing a plurality of the dispensers and spacing them about a plurality of plants; providing a substrate for insect control in each dispenser; and allowing for the dispenser to attract a target insect.

In the foregoing method or any other embodiment of a method of insect control, the method may include a step of coupling the dispensers to irrigation line(s) associated with the plants.

In the foregoing method or any other embodiment of a method of insect control, the method may include a step of using the irrigation line(s) to wet the substrates in the dispensers.

In the foregoing or any other embodiment, a stake may be disposed on the dispenser or packaged with the dispenser. The stake may be coupled to an irrigation line or section thereof.

In another possible embodiment, the inventive subject matter is directed to a method of pest control or management. The method includes steps of providing a plurality of dispenser systems for pest management. Each dispenser includes: one or more sidewalls extending upwardly from a bottom wall of the dispenser. At least one aperture is disposed in a wall that is sized and shaped to allow ingress of a target insect type. A receptacle for supporting the substrate disposed in a space defined by the sidewalls and bottom wall. A substrate may be a composition that is an active agent for management or control of the target insect type. Each of the dispenser height, width, and depth dimensions is between 1 cm to 30 cm. The method includes a step of placing the dispenser system in a site comprising a plurality of plants susceptible to the target insect.

In the foregoing method or any other embodiment of a method of insect control the site may be a site with a plurality of fruit plants.

In the foregoing method or any other embodiment of a method of insect control the target insect may be a fruit fly species. The fruit fly species may be SWD.

In the foregoing method or any other embodiment of a method of insect control, the dispenser may be provided at a rate of at least 20 dispensers per hectare, with generally uniform spacing of plants and dispensers.

In the foregoing method or any other embodiment of a method of insect control, dispensers are placed at a rate of fifty (50) dispensers per acre (124 dispensers/ha) among the susceptible plants.

In the foregoing method or any other embodiment of a method of insect control, a minimum of ten (10) dispensers are used and are spaced up to 13.33 m apart from each other among the plants.

In the foregoing method or any other embodiment of a method of insect control, there may be a step of periodically hydrating the substrate in the dispenser.

In the foregoing method or any other embodiment of a method of insect control each dispenser may be coupled to an irrigation line, the irrigation line having apertures for and being oriented relative to the dispenser so that fluid can be directed into the dispenser and wet the substrate.

In the foregoing method or any other embodiment of a method of insect control, the irrigation line is may be associated with the susceptible plants and is an irrigation line for the plants.

In the foregoing method or any other embodiment of a method of insect control, the substrate may be a composition that serves as an attractant, behavioral arrestants, developmental arrestants, deterrent, and/or stimulant that is active against the target insect.

In the foregoing method or any other embodiment of a method of insect control, the substrate may be a semiochemical that induces ovipositioning in the target insect.

In the foregoing method or any other embodiment of a method of insect control, the fruit plants may be blueberry, raspberry, blackberry, other berry crop plants or cherry plants (trees) or grape plants.

Any dispenser of according to the inventive subject matter may have a height of 4 to 30 cm and width (or diameter) of 4 to 30 cm.

Any dispenser of according to the inventive subject matter may have a receptacle that has a surface area of 3 cm² to 60 cm². The following is a description of various inventive lines under the inventive subject matter. The appended claims, as originally filed in this document, or as subsequently amended, are hereby incorporated into this Summary section as if written directly herein.

### BRIEF DESCRIPTION OF THE DRAWINGS

The appended figures show embodiments according to the inventive subject matter, unless noted as showing prior art.

FIG. 1 shows a side perspective view of dispenser assembled with a top lid.

FIG. 2 shows an elevational view of a first side of the dispenser of FIG. 1 (an opposing side is a mirror image).

FIG. 3 shows the same view of the dispenser of FIG. 1 but without the top lid.

FIG. 4 shows a plan view of the dispenser of FIG. 3, showing details of the interior of the dispenser.

FIG. 5 shows the dispenser of FIG. 2 but without the top lid.

FIG. 6 shows an elevational view of a second side of the dispenser of FIG. 1 (an opposing side is a mirror image).

FIG. 7 shows a cross sectional view of the dispenser of FIG. 6 taken along line 7-7, with the lid not shown.

FIG. 8 shows an enlarged area from FIG. 7 indicated by circle C in FIG. 7.

FIG. 9 shows a bottom view of the dispenser and lid of FIG. 1.

FIG. 10 shows a top perspective view of the lid from FIG. 1

FIG. 11 shows a side elevational view of a first side of the lid from FIG. 10.

FIGS. 12A and 12B show the dispenser and lid from FIG. 1 being coupled to (12A), and then coupled to (FIG. 12B), an irrigation line in a field.

FIG. 13 shows the dispenser and lid from FIG. 1 coupled to an irrigation line on media contained in plant pot.

FIG. 14 shows the dispenser and lid from FIG. 1 coupled to an irrigation line suspended above the ground through crop plants.

FIG. 15 shows a side perspective view of another embodiment of a dispenser.

FIG. 16 shows a plan view of the dispenser of FIG. 15.

FIG. 17 shows an elevational view of a first side of the dispenser of FIG. 15 (an opposing side is a mirror image).

FIG. 18 shows an elevational view of a second side of the dispenser of FIG. 15, which is orthogonal to the first side (an opposing side to the second side is a mirror image)

FIG. 19 shows a top perspective view of another embodiment of a lid usable with dispensers disclosed herein.

FIG. 20 shows a side perspective view of yet another embodiment of a dispenser, which includes a stake.

FIG. 21 shows an elevational view of a second side of the dispenser of FIG. 20 (an opposing side is a mirror image, and both are similar to the second side shown in FIG. 6, except with a different aperture configuration in the lower portion).

FIG. 22 shows a cross sectional view of the dispenser of FIG. 21 taken along line 22-22.

FIG. 23 shows a bottom view of the dispenser of FIG. 20.

FIG. 24 shows an elevational view of a first side of the dispenser of FIG. 20 (an opposing side is a mirror image, and both are similar to the first side shown in FIG. 2, except with a different aperture configuration in the lower portion).

FIG. 25 shows a bottom view of the dispenser of FIG. 20.

FIG. 26 shows a top perspective view of another embodiment of yet another embodiment of a lid usable with dispensers disclosed herein.

FIG. 27 shows a side perspective view of still another embodiment of a dispenser, which includes a bottom aperture for receiving a removable stake.

FIG. 28 shows an elevational view of a second side of the dispenser of FIG. 27 (an opposing side is a mirror image, and both are the same as the second side shown in FIG. 21, except the stake is not shown).

FIG. 29 shows a cross sectional view of the dispenser of FIG. 28 taken along line 29-29.

FIG. 30 shows a bottom view of the dispenser of FIG. 20.

FIG. 31 shows an elevational view of a first side of the dispenser of FIG. 27 (an opposing side is a mirror image, and both are similar to the first side shown in FIG. 24, except the stake is not shown).

FIG. 32 shows a bottom view of the dispenser of FIG. 27.

FIG. 33 shows the dispenser and lid from FIG. 27 coupled to stake with an irrigation line.

### DETAILED DESCRIPTION

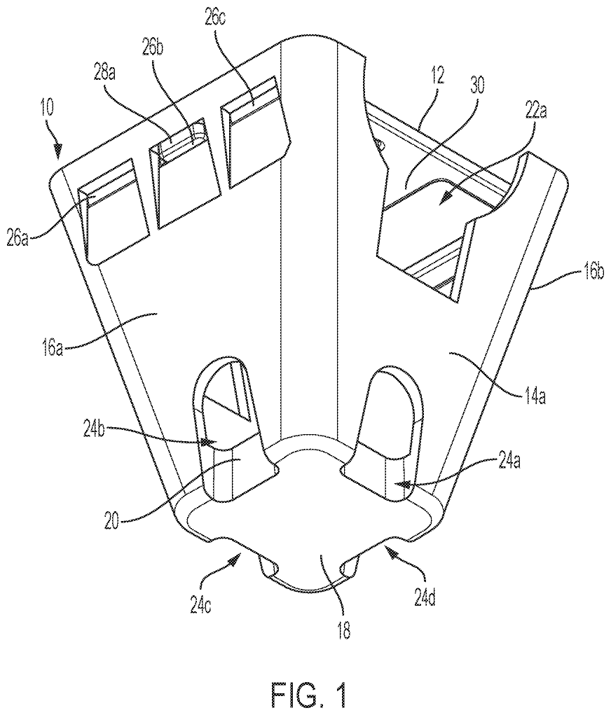

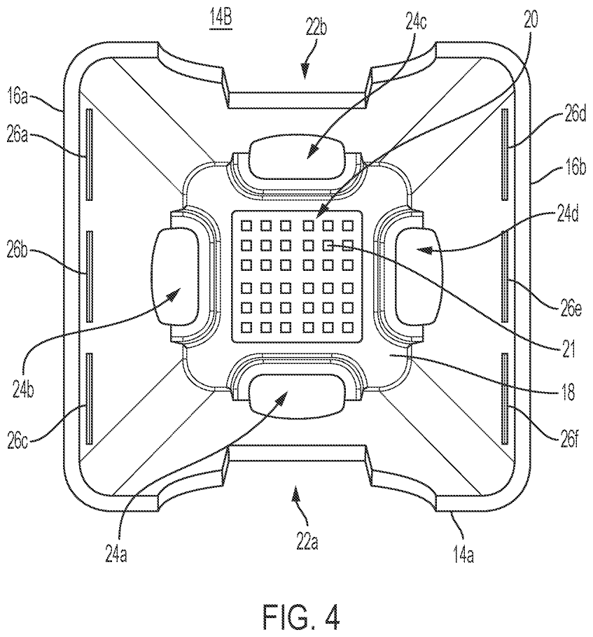

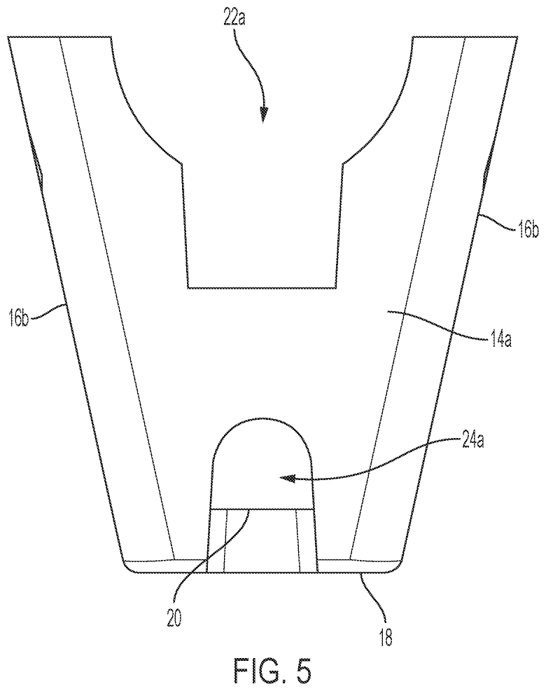

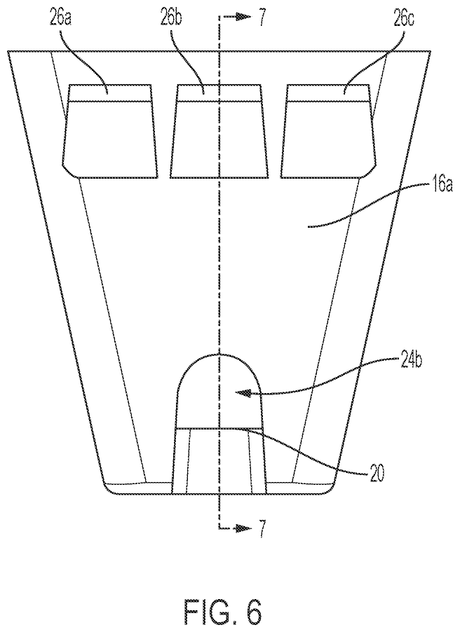

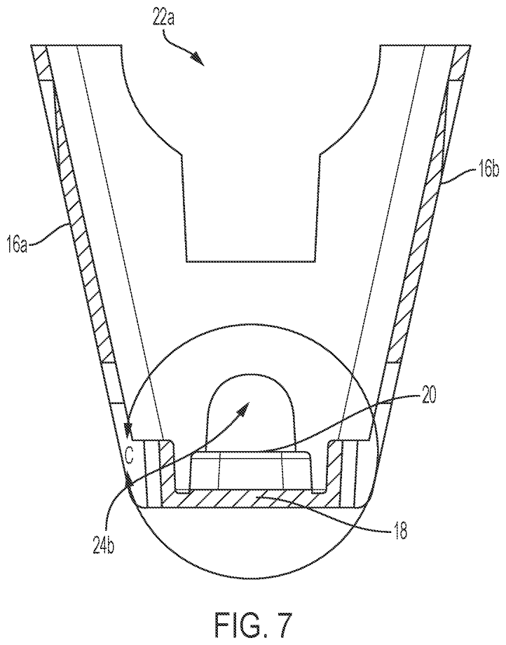

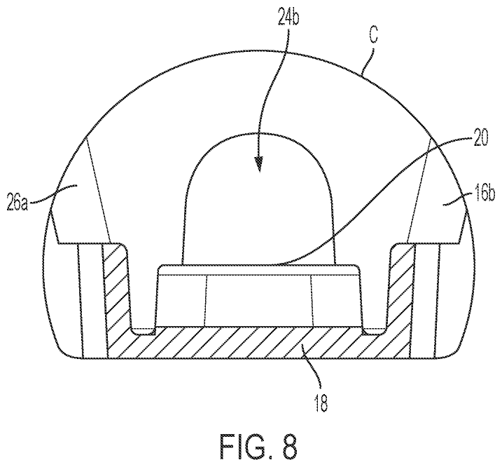

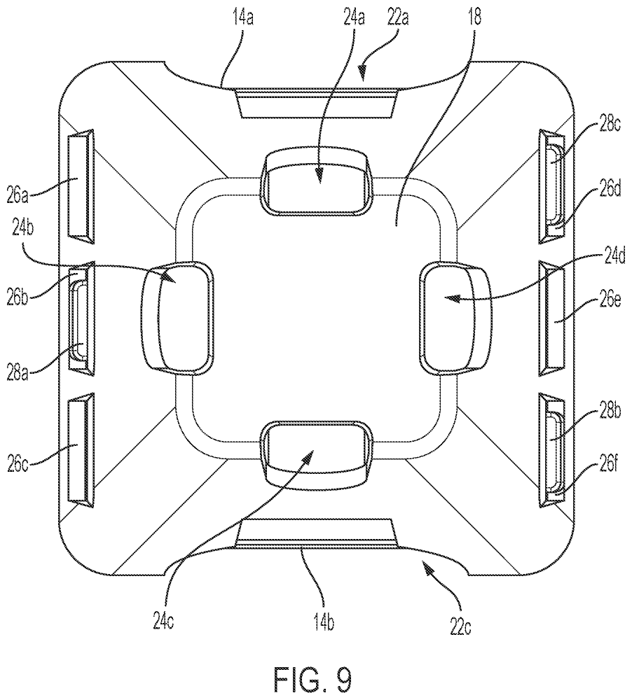

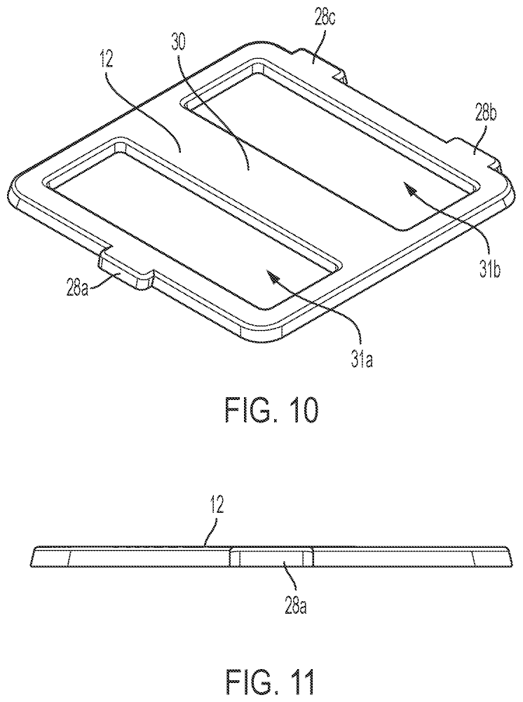

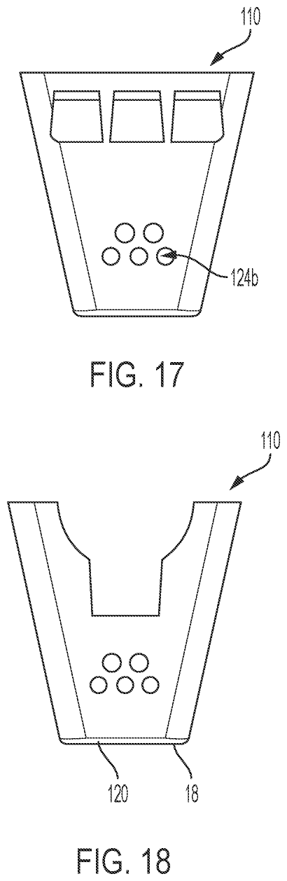

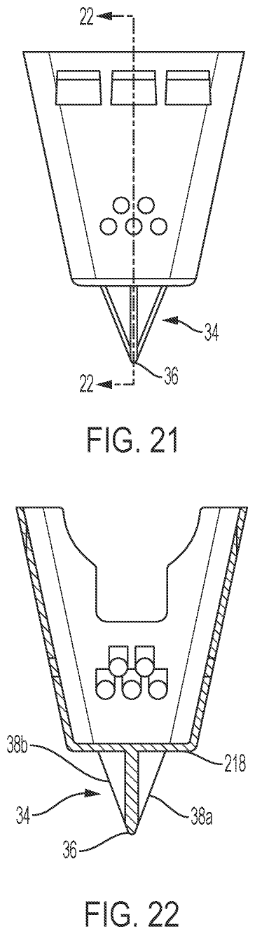

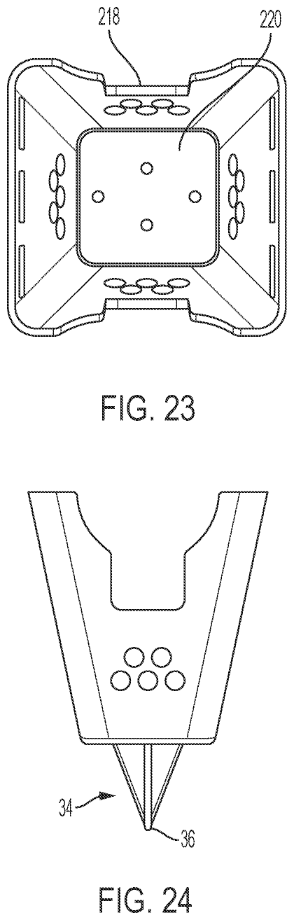

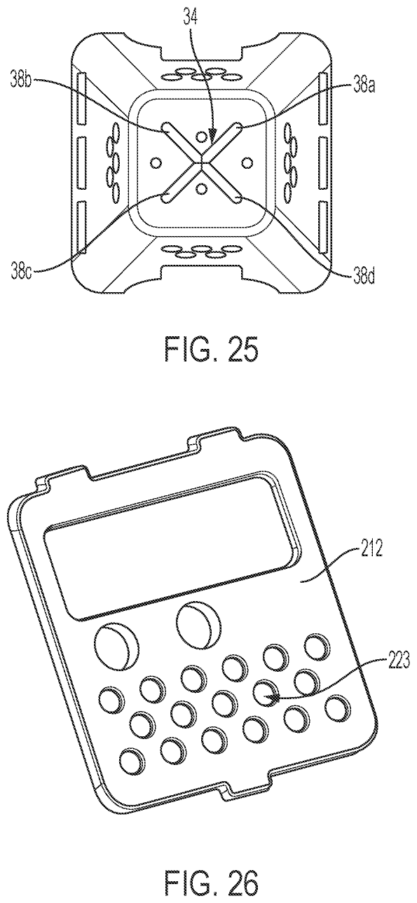

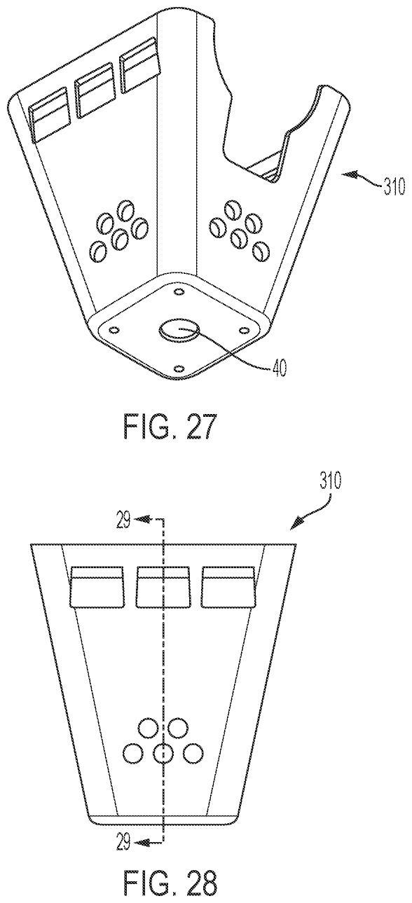

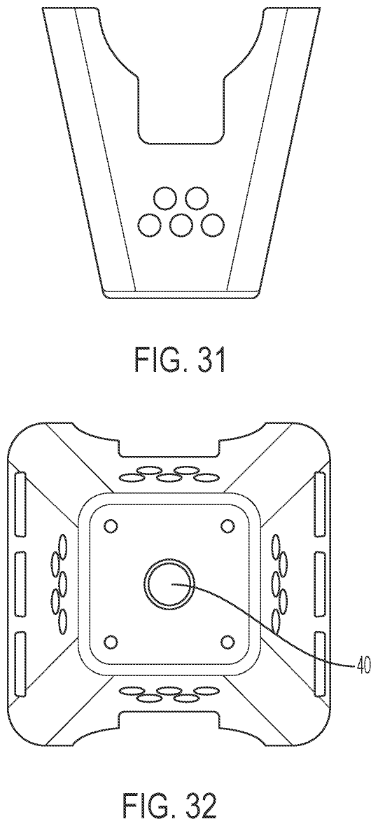

Representative embodiments according to the inventive subject matter are shown in FIGS. 1-33, wherein the same or generally similar features share common reference numerals.

The inventive subject matter generally relates to systems and methods for controlling insect population size for a selected species of insect. In certain aspects, it relates to systems and methods that use agents that affect insect behavior or biology, e.g., behavioral arrestants that divert insects to oviposition at target sites that disrupt the viability of eggs, larvae, pupae, or which otherwise detrimentally affect insect populations, e.g., killing the insect or rendering it infertile.

In one possible embodiment, the inventive subject is particularly suited to diverting fruit-infesting insects like fruit flies from their natural fruit or plants oviposition sites to a substrate that serves as a substitute oviposition site. The substrate may thereby receive eggs so that another component of the substrate, or aspect of the dispensing system holding the substrate, detrimentally affects egg viability or otherwise disrupts insect reproduction or other predetermined biological attribute.

In certain embodiments, the substrate is a substitute oviposition site in a dispensing system. The substrate includes a behavioral arrestant selective to the insect and an egg, larvae, or pupae disruptor, such as a desiccant contained in the substrate. Alternatively, the disruptor could be separate from but near enough the substitute oviposition site to be operationally effective. For example, it could be component of the dispensing system that has a volatile agent that disrupts eggs or otherwise affects reproduction of the eggs or the laying female.

FIG. 1 shows an exemplary dispenser for use with a substrate that substitutes for a natural oviposition site. The dispensing system includes one or more receptacle areas for receiving one or more substrates. The substrate may be in the form of a tablet. Alternative forms, may include sheets of material, powdered or granular material, or liquids or gels. As discussed in more detail below, a substrate may be provided in an initial form that changes under conditions of use, e.g., a solid to a gum or viscous composition. The initial form of the substrate may be a solid, gel, powder or particulate, or liquid.

In the embodiment shown, the container structure has a bottom surface and upwardly surrounding walls disposed around the perimeter of the bottom surface. The container may have four sidewalls or any other number of sidewalls or shapes that create a container. For example, the container could have a round shape in any cross section. Although the embodiment shown in the Figures has sidewalls surrounding the bottom wall, in other embodiments, the bottom wall or receptacle need not be completely surrounded by sidewalls, i.e., there can be one or more fully or partially open sides. The area of the dispenser inward of the sidewall(s) includes a receptacle, i.e., a surface or other structure for supporting a substrate.

FIGS. 1-14 show different views of one possible embodiment of a four-sided dispenser 10 according to the inventive subject matter. In general, the dispenser includes a receptacle area 20 within an area defined by the walls of a dispenser for holding a substrate that affects insect behavior. In the example shown, the dispenser includes four sidewalls 14a-14b, 16a-16b, and a bottom wall 18. The bottom wall has an outwardly facing surface and inward facing surface. The sidewalls and bottom wall are arranged to form a container with an open-ended top. Receptacle 20 is disposed on the inward side of bottom wall 18. It may be a flat or raised area (i.e., extending upwardly and above the bottom edges (i.e., resting surfaces) of the sidewalls, as seen in FIG. 1, for example.

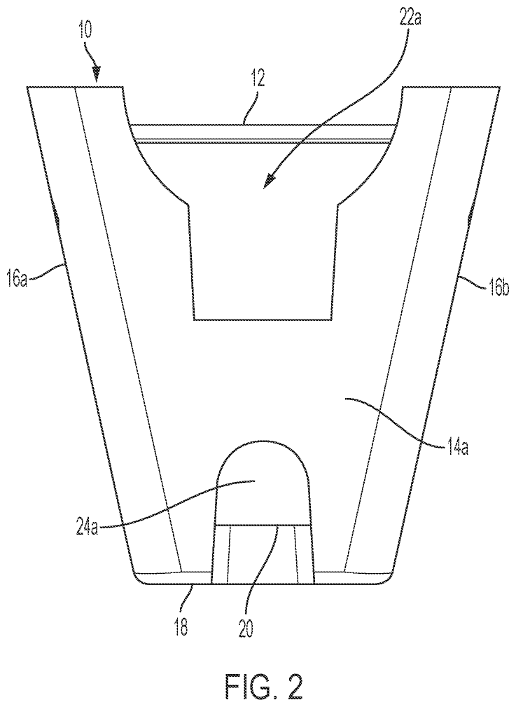

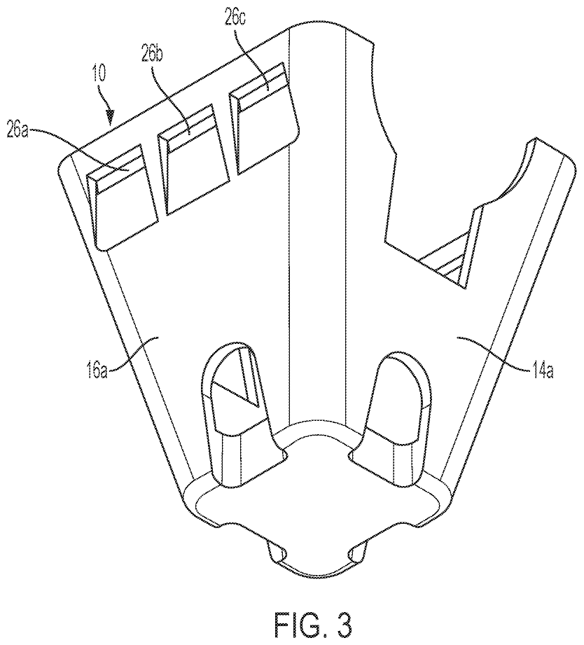

In the illustrated embodiment, dispenser 10 includes an optional cover or lid 12. The lid 12 can be fitted over the open top end of the dispenser. FIGS. 1-2 show dispenser 10 with the lid in place; FIG. 3 shows the dispenser with the lid removed. In this example, the lid is removable but in other embodiments it could be fixed in place or hingeably connected. There are two pairs of opposing sidewalls. Sidewalls 14a and 14b form a first pair of opposing sidewalls. Sidewalls 16a and 16b form a second pair of opposing sidewalls that are orthogonal to sidewalls 14a and 14b. The dispenser has a general shape like a truncated pyramid.

Dispensers according to the inventive subject matter have a set of one or more functional attributes. The dispenser may include a receptacle area for supporting a substrate. The dispenser may allow for insect ingress. The dispenser may allow for easy wetting or moistening of the substrate on the receptacle to turn it into a gum, or to allow for release of active agents. The dispenser may be configured to support the substrate above standing water. Similarly, the dispenser may allow for easy coupling to irrigation lines that provide the wetting or for coupling to other objects to secure a dispenser in place. The dispenser may allow for easy addition of substrates onto the receptacle to replenish used substrates. The dispenser may include a staking system for fixedly or adjustably immobilizing the dispenser relative to another object. Methods of deploying insect control compositions using dispensers are also contemplated.

A substrate such as a tablet can be placed on top of receptacle 20. In the illustrated embodiment, receptacle 20 is a raised area extending upwardly from bottom wall 18. The substrate-receiving surface of receptacle 18 may be structured or textured to help engage a substrate. It may be planar or bowled to hold different forms of substrates, e.g., solids, liquids, etc. In the illustrated embodiment, receptacle 20 has a planar surface that includes a hatched structural finish 21 to help seat and secure a deposited substrate. In other possible embodiments, the receptacle could be ledge, compartment, or pocket disposed in the dispenser. Any such structure may be raised an appropriate height above the bottom of the dispenser to avoid standing water or soil infiltration, for example. Other suitable receptacle structures include a hook, which could be associated with a sidewall onto which a substrate or container of the substrate can be hung. In yet another possible embodiment, the substrate, or any container or packaging for it, could include an adhesive patch for coupling a substrate to a wall of the dispenser. Similarly, the dispenser itself could include an adhesive patch for coupling to a substrate or its associated container or packaging.

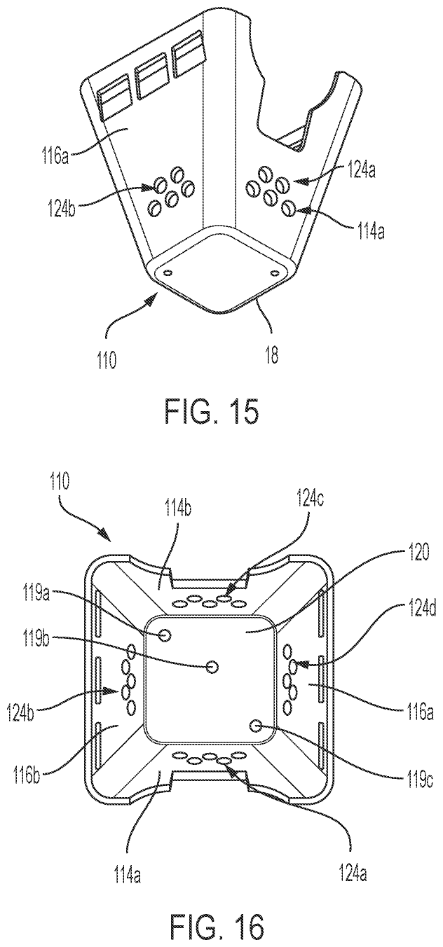

The bottom portion of each side wall 14, 16 includes an opening or aperture 24a-24c. One possible function of an opening 24 is to allow for drainage of water or other liquids from the inside of the dispenser, as discussed in more detail below. Another possible function of an opening 24 is to allow insect ingress into dispenser 10. In this regard the openings should be sized and shaped large to allow a target insect to enter the dispenser. These openings are shown extending upwardly from bottom wall 18 to at least above the height of receptacle's substrate-receiving surface 20. However, the top of an opening 24 need not extend above the height of the receptacle's surface if other apertures are provided for drainage or insect ingress. While drainage could be achieved by placing the openings at the base of the dispenser close to the bottom of the sidewall 18 (See, e.g., the embodiment of FIGS. 15-16, such placement is also possible at the base (horizontal bottom wall 18). The sidewall holes can therefore allow for both ingress of insects and egress of excess water on sidewalls, whereas the base surface wall functions to drain (allow egress) of excess water. However, an aperture bottom wall may not allow for insect ingress for dispensers placed on a solid surface, and such positioning of apertures could be subject to clogging by soil or other media onto which they are placed.

Another possible function of an opening 24, or any other opening in the dispenser, is to allow for venting of substrate volatiles or to help control moisture levels in the dispenser. The opening location, size, and numbers may be varied to achieve desired effects. For example, although dispenser 10 is shown with an opening or aperture 24 on each sidewall, in other possible embodiments, the dispenser may include fewer or more openings. They may be selectively sized and shaped to screen out other insects or animals having a larger size.

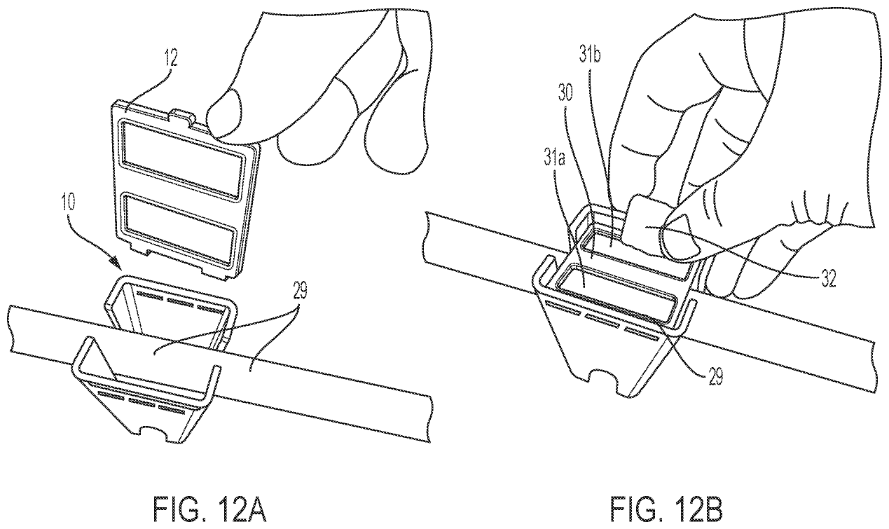

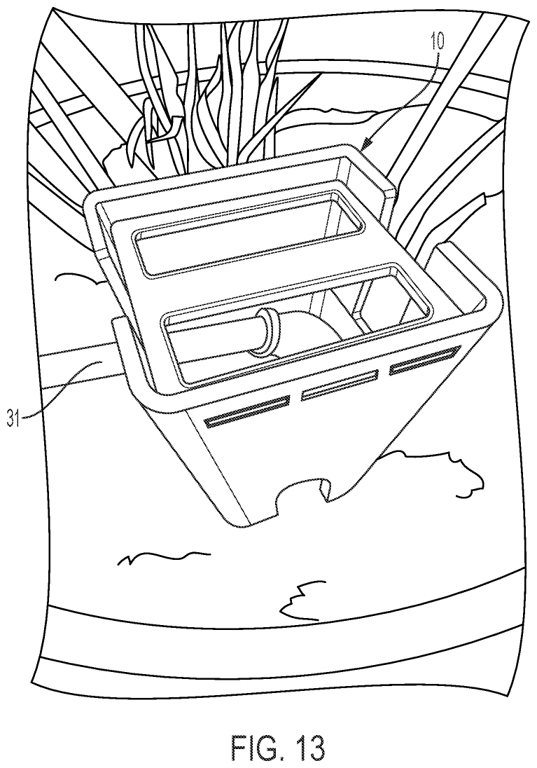

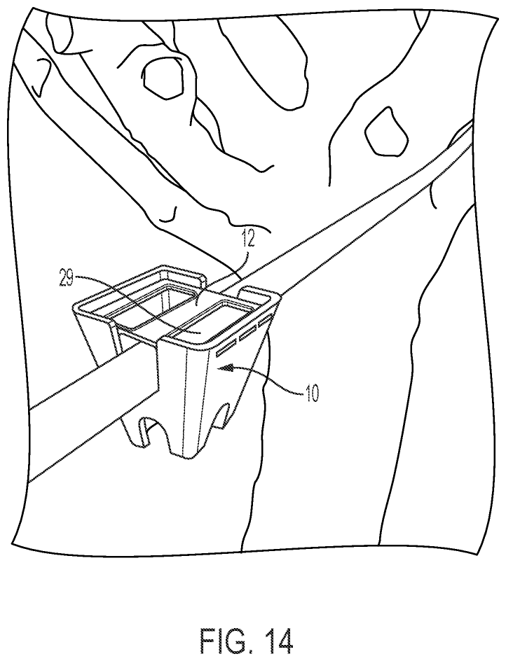

FIGS. 12-14 show possible site implementations of a plurality of dispenser systems 10. As seen the dispenser system may be associated with a section of irrigation line that is used to irrigate one or more crop plants. Dispensers can be placed resting on soil (FIGS. 12A-B), resting in the media of a pot (FIG. 13), or suspended above the ground (FIG. 14 between plants or in a plant.

Opposing walls and 14a and 14b each include apertures 22a and 22b that are generally parallel or otherwise aligned to one another and receive a section of irrigation line that runs through or by a plurality of irrigated plants. The received section of irrigation line 29 may include apertures that drip or spray water into the dispenser and over the substrate held on the receptacle. This allows for moistening of certain substrates so that, for instance, they can turn into a gummier or otherwise less solid form or so that a substrate's interaction with water or other deposited liquid promotes release of functional volatiles, improve tactile qualities of a substrate, or release substances from a substrate that promotes egg-laying behavior. There is a squared area extending below the round area of apertures 22. The round area could accommodate irrigation lines of a first size or size range and the squared area could accommodate irrigation lines of a second size or size range different from that of the rounded area. For example, the rounded area could accommodate ½″ (12.7 mm) to 1″ (25.4 mm) line 29 and the lower squared area could accommodate ¼″ (6.35 mm) line.

In the embodiment of FIG. 13, a different version of an irrigation line 31 is shown. In this version, an end section of a narrower diameter irrigation line for potted plants extends into the lower squared area of one of the apertures 22. Water emitted from the end section can moisten a tablet-form substrate on a receptacle in the dispenser. In other possible embodiments, the container itself could have an integrated nozzle or port on an inner surface that is oriented to direct water to the receptacle area. A connector like a threaded collar could be integrated on an outer surface for mating engagement with complementary connector on an irrigation line. In other embodiments, the dispenser could include a reservoir for water that is coupled to a nozzle or port that directs water to a receptacle area. As noted, to prevent overwatering of the substrate, water can drain through apertures, such as apertures 24.

Looking more particularly at irrigation-line apertures 22a and 22b, they may be sized and shaped to receive an irrigation line of a single size or multiple sizes. For example, the apertures may be sized so that the irrigation line can be received in a tight or snap-fit fashion or a loose fashion.

Lid 12 may securely, removable or hingeably engage with the dispenser. For example, the lid may include a set of tabs 28a-28c on opposing edges that engage with complementary slots 26a-26f that are disposed at the top of the dispenser. Lid 12 may be placed over the top of the dispenser with an irrigation line disposed in apertures 22a and 22b, thereby coupling the dispenser and irrigation line together. With the lid is so engaged, it allows for the dispenser to stay on a path of the irrigation line, whether the line is on a surface or in the air. For example, FIG. 14 shows dispenser 10 secured to a suspended section of irrigation line.

In other possible embodiments, alternative means may be provided to suspend dispensers from objects or to secure dispensers to desired locations. For example, the exterior and/or interior surfaces of dispensers may include hooks, straps, loops, wires, clips, bands, tabs for nailing or pinning to objects, adhesive patches, stakes, etc. Such items may be integral with the dispenser or attachable thereto.

As seen lid 12 does not need to completely cover the open top end of the dispenser. It has a central bar section 30 that can coincide with the path of the irrigation line though the dispenser and can have open areas 31a, 31b to the left and right sides of the bar section. The openings 31a and 31b may be sized and shaped to allow for deposit substrates 32 onto the receptacle 20, as well as for possible insect ingress or ventilation.

Advantageously, dispensers constructed according to the foregoing principles allow for long-lasting, constant release of a substrate's volatile compounds like deterrents, attractants, behavioral arrestants, developmental arrestants, and/or stimulants. This is particularly true for substrates based on food grade gums that include behavioral arrestants. The dispenser supports the gum in a moistened form for release of volatiles over reasonable durations related to reproductive cycles of the target insect. The substrates can be replenished easily and as needed by simply dropping substrate, e.g., tablets, in the in-situ dispensers. As used herein, a developmental arrestant includes substances that interrupt the normal development of an insect, or a substance that stops a chemical reaction that causes insects to aggregate or slows the movement of insects. As used herein, an attractant includes substances (such as a pheromones) that attract specific insects (or individuals of the opposite sex), any other insect attracting agent or substance, or a lure. A behavioral arrestant may also be an attractant.

The foregoing description of dispensers is not limiting. From the teachings herein, persons skilled in the art will appreciate that various other versions of dispensers can be made having different scales, dimensions, shapes, and feature sets.

Dispensers according to the inventive subject matter can be formed as a unitary or multipiece structure using known thermoplastic molding processes. The dispenser could be made of any other firm or semi-rigid materials material that can be formed into container with features and functions as contemplated herein.

A representative example of using the dispenser according to the inventive subject matter, includes the following method steps:

The method assumes D. suzukii as the target insect and target crops cherries, wine grape, blueberry, raspberry, or blackberry. The substrate has a base of a food grade gum and a behavioral arrestant, and it may be formulated as contemplated elsewhere in this disclosure.
Step 1: Place dispenser directly under dripper line and secure receptacle. Fifty dispensers/acre and 124 dispensers/hectare.
Step 2: Place a substrate tablet every 21 days into receptacle. Irrigate every 1-3 days preferably early afternoon.

The method steps are informed by the following information based on actual research or prophetic illustration.

Insect navigation directed by plant chemical cues is vitally important to the conceptualization of new control strategies. Research has compared the effectiveness of various controlled-release devices used for spotted-wing drosophila (SWD) behavioral control to the effectiveness of a food-grade behavioral arrestant, or attractant. In prior studies, dispensers of several materials and designs were evaluated for their ability to retain water and support the release of volatile emissions from behavioral arrestant. However, water retention alone was insufficient to provide long-lasting term efficacy in the field. Results showed that daily wetting is critical to avoid desiccation of the food grade behavioral arrestant or attractant and to maintain its optimal volatile emission level for over time. To address this need, existing materials were adapted as alternate dispensers to be directly connected to the drip irrigation system; their effectiveness was tested under field conditions. With this approach, volatile emissions from each food-grade-behavioral arrestant point source filled a 6 m (20 ft) radius. Effective SWD behavioral control required only 20 dispensers per hectare.

In considering spacing, the dispensers would be spaced apart in a generally uniform manner among the target crop plants, which would also be spaced apart in a pattern typical of a specific crop. The basic idea is to create a blanket of volatiles over the pattern of plants in a crop site sufficient to cause the intended effect of active, volatile agents in a substrate on the target insect population. An arrangement of dispensers among a pattern of crop plants that achieves this objective may be considered to have a “generally uniform spacing.”

Red is believed to be an attractive color for sticky traps and may be a useful color for dispensers or components thereof. The number and size of entry-holes in a dispenser may be important according to the size and behavior of the specific species. Hole sizes need to be large enough to allow ingress of target insect, providing such insects to easily contact the behavioral arrestant or attractant. It may also be helpful to include mold inhibitors in a substrate that is to be wetted. Examples include citric acid, calcium propionate.

In addition to food grade gum, other substrates that may be suitable include microbially created mycelium, hemp fibers, cotton fibers, and other absorbent manmade or natural fibers or textiles (e.g., Lyocell, Rayon, Bamboo, Synthetic or natural microfibers, Linen, Wool, Fleece, Flannel, Abaca, Coir, Flax, Jute, Sisal, Alpaca, Angora, Camel, Cashmere, Mohair, Silk).

In one possible embodiment, a dispenser has a height of 4 to 30 cm and width (or diameter) of 4 to 30 cm. The receptacle has surface area of 3 to 60 cm². The receptacle is 2 to 10 cm above the bottom of the dispenser. The apertures for drainage at the bottom of the dispenser are 0.05 cm² to 10 cm². The apertures for receiving irrigation line are 2-10 cm².

FIGS. 15-18 show an alternative embodiment of a dispenser 110 with a different arrangement of apertures 124a, 124b, 124c on sidewalls 114a-d, 116a-d, and bottom wall 118. In this embodiment relative to that of FIGS. 1-14 there is a plurality of relatively small apertures on each of the side walls, although not all sidewalls need to have apertures. The apertures are disposed in lower portion of the dispenser. The holes may vary in size and density. They may be sized to prevent ingress or egress of insects of a certain size and/or to allow ingress or egress of insects of a certain size. Suitable hole sizes for use with SWD may range from 4 mm-6 mm. There may be 1, 2, 3, 4, 5, 6, 7, 8, 9, 10 or more holes on any given side. Similarly, bottom surface 118 may include one or more such holes, e.g., holes 119a-c. In this embodiment, in contrast to earlier discussed ones, the receptacle 120 is not appreciably raised above the bottom edges of the sidewalls, as seen in the cross-section of FIG. 18.

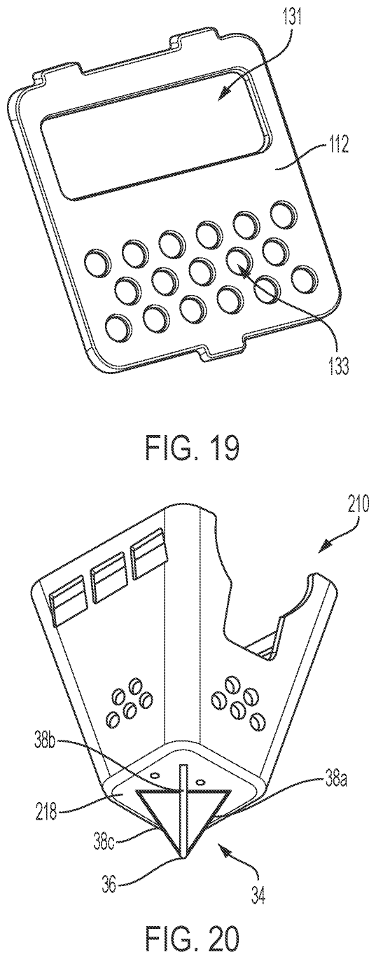

FIG. 19 shows an alternative lid 112 that can be used with a dispenser. Lid 112 has more coverage area, with the area of additional coverage being apertured. On one side of the lid is a large aperture 131 like that of aperture 31 in lid 12. On the other side is a solid surface with a pattern 133 of small apertures. The pattern may have apertures of similar size to the sidewalls 14, 16 or bottom wall 18. The use of smaller apertures for more covered area helps filter out insects that are too large to fit through the provided apertures and/or allows for maintenance of a more humid environment for better management of a substrate that needs to be in a moistened condition.

FIGS. 20-25 show another possible embodiment similar to the embodiments of other Figures discussed above, which includes a stake 34 for fixing the dispenser into soil or other penetrable medium. The dispenser is generally the same as those discussed above, with certain differences noted. In this embodiment, dispenser 210 includes at least one stake 34 that downwardly extends from the bottom wall 218 of the body of the dispenser. A receptacle 220 on the opposite side of the bottom wall can be configured like receptacle 20 or 120 or in any other suitable manner. In this example, a single stake is disposed centrally on the bottom surface of the dispenser. In other embodiments, two, three, four or more stakes can be spaced apart and extend downwardly below the dispenser body. For instances there could be four stakes disposed at corners of the bottom of the dispenser. In other possibilities, one or more stakes are disposed on one or more sides of the body of the dispenser instead of or in addition to the dispenser's bottom surface. The stakes may be integrally formed with the body of the dispenser (e.g., molded in a unitary construction, heat fused, glued on, bolted on, etc.), or they may be removable disposed on the body of the dispenser (e.g., snapped on, threaded on, magnetically attached, etc.).

Looking more closely at the embodiment shown, stake 34 has an elongate form with a spiked end 36. There is a downward tapering of the stake moving from an upper to lower portion The stake has a finned configuration, with two pairs of orthogonally opposed fins 38a-38d, i.e., fins arranged 90 degrees apart. Each fin aligns with a corner of the dispenser. Various other arrangements are possible. Stakes may come in many other forms that allow for penetration and purchase into a given medium. The stakes may be made of any firm material, including plastics or other moldable material, wood, metal, composites, etc.

In some embodiments, the inventive subject matter is directed to a dispenser system that includes a stake. The stake and dispenser are coupled so that the dispenser is immobilized relate to the stake or at a specific location, e.g., at a ground or plant position. For example, a stake affixed to the dispenser would be an arrangement where the dispenser is immobilized relative to the stake. When the stake is planted on the ground or in a potted plant, the dispenser would also be immobilized relative to the ground or a plant. If the dispenser were slidably coupled to the stake along a vertical or horizontal axis, that would be an example where the dispenser would not necessarily be immobilized relative to the stake but would be relative to a position above the ground or to the side of a plant, depending on which axis is restricted. Restricting one axis and unrestricting and other may be desirable where adjusting the spacing of the dispenser above the ground or from the side of a plant may be desirable.

FIG. 26 shows an embodiment of a lid similar to that of FIG. 19 but in this case the apertures 233 have varying size. Apertures allow for placement of staked dripper dispenser.

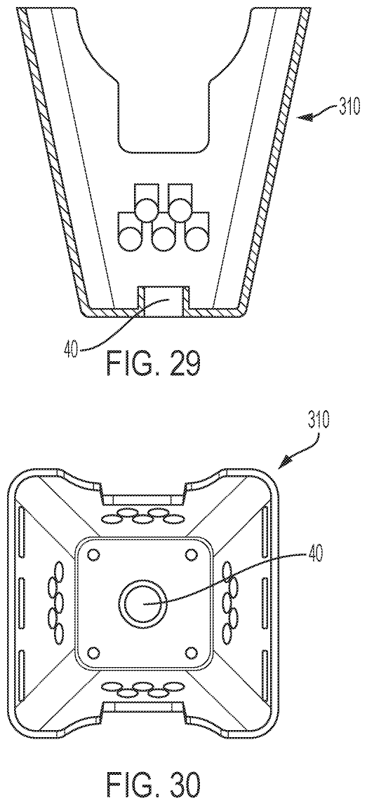

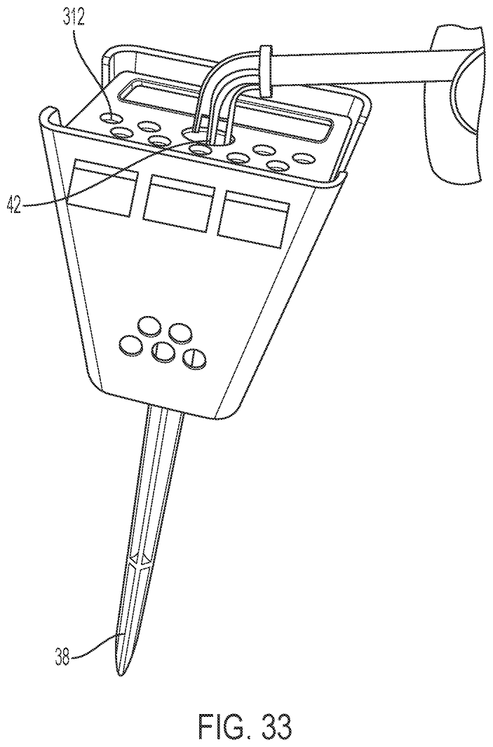

FIGS. 29-33 show an embodiment of a dispenser 310 similar to that of the earlier Figures but which is configured to assemble with a separate stake 38 (FIG. 33). Dispenser 310 includes an aperture 40 with which an upper portion of a stake can inserted. The aperture and upper portion of the stake may be sized and shaped for a friction fit so that the dispenser and stake are connected together or relatively immobilized relative to one another. The portion of a stake that is engageable with an aperture may or may not have a shape that is cross-sectionally complementary to the aperture. For example, a stake with a circular cross section that has an outer diameter the same as or slightly less than the diameter of a circular aperture for frictional engagement is an example of complementary cross sections. In contrast, a finned stake, as seen in the FIG. 33 could have sets of opposing fins that radiate outwardly so that each pair of fins has a width the same as or slightly less than the diameter of a circular aperture so that the end walls of the fins frictionally engage with the walls of the aperture. This would be an example of non-complementary cross-sections. In other words, circumferential engagement with the aperture may be full or partial, so long as it is sufficient to couple the stake to the dispenser. Sufficient engagement means at least a sufficient engagement so that dispenser is immobilized relative to the stake and, for example, moderate wind, gravity, or light bumping does not displace the stake and dispenser from each other when the stake is planted into the ground or, so the dispenser is not displaced relative to a ground position or plant position.

As noted, other means of engagement include use of complementary threads in the surface walls of the aperture and on the stake's end portion. In other embodiments, the aperture need not firmly engage with the stake. Instead, as seen in FIG. 33, the stake's upper portion may extend through the aperture and through an aperture 42 in the dispenser's lid 312. The lid aperture may be the one that engages the stake to couple it to the dispenser assembly The aperture in the bottom wall of the dispenser and the lid align to arrange the stake in a vertical orientation so that it may be driven into soil or other medium. Naturally, either or both the bottom aperture and the lid aperture may be configured to engage and create a connection with the stake.

A stake and aperture can have varying geometrical configurations and are not limited to any particular configurations, including circular, polygonal, star-like. For example, a stake with four fins, as seen in the Figures, could be disposed in an aperture with a complementary pattern. The stake may come in a variety of sizes sufficient to immobilizing a dispenser in a desired position, and it may be sized to allow for a vertical and/or horizontal adjustments. For providing purchase in soil, typically a stake would typically have a length of at least 3 cm. Stake height may vary according to crop type. For example, a dispenser that needs to be placed near the canopy of a bush or fruit tree may need a height of 1 m or more. It can be provided with extra height and adjustability to correspond to the height of a plant as it grows or is cut back.

While the illustrated embodiments may couple a stake via engagement with apertures in the dispenser and/or dispenser lid, the inventive subject matter also contemplates other means of mechanical or other engagement. For example, the dispenser or the stake could have a C-track or strut channel that engages with a protruding element the other of the dispenser or stake, with the protruding element being configured to be received and retained in the channel. In other embodiments, the sides of the stake and dispenser could engage using complementary pairs of male-female elements that snap fit together. In yet other embodiments, the stake and dispenser may have complementary magnetically attractable elements or portions for magnetic engagement. Other possibilities include peel and stick adhesive patches on one or both of the dispenser and stake or use of complementary hook and loop fasteners on the dispenser and stake.

The stake may be configured with openings, nozzles, or channels to deliver moisture or other substances into the dispenser. For example, water to substrates placed inside the dispenser or to adjacent plants. The stakes can serve multiple functions. In one possibility, the stake is configured to deliver (1) water or other substance into the dispenser, e.g., onto a substrate on the bottom of the dispenser, and (2) water or other substance onto an object, e.g., a plant outside the dispenser. To deliver a substance into the dispenser, the stake body could have channels that are coupled to a conduit (e.g., an irrigation line), the channels fluidly communicate with openings that emit the substance in a desired direction. Or it could have a nozzle that sits above or within the dispenser that can direct a substance into a target area within the dispenser.

To deliver a substance to an object outside the dispenser, the stake may include a nozzle or opening that extends outside the dispenser and can emit the substance in a desired direction. For example, the nozzle could be any kind of standard irrigation nozzle used in residential, commercial, or agricultural plant irrigation. The conduit for the emission of substances externally of the dispenser may be adjustable in terms of direction, spray volume, and/or spray pattern. Likewise, a nozzle sitting above the dispenser or within the dispenser for directing a substance to a target area within the dispenser could have similar adjustability.

In some embodiments, the stake may be a commercially available drip irrigation stake or support irrigation support stake used in drip line systems. The dispenser may be configured with openings that are configured to engage with the geometrical configuration of a commercially available stake so that the dispenser is immobilized relative to the stake or ground or plant position.

### Open Field Active Distance Efficacy Trial

The following is a description of field testing for the inventive subject matter. The testing parameters provide representative uses of the inventive subject matter and are not intended to create limitations on parameters of use. For an open active distance trial, experiments were conducted from 13 September to 15 Oct. 2019 at the Lewis Brown Farm at Oregon State University (44°33′13″N, 123°13′07″W) on 15-year-old ‘Elliot’ blueberry plants. One acre was subjected to the trial and divided in two plots. Plants were spaced approximately 0.76 m apart within rows and 3.05 m between rows. Plants were approximately 1 m wide and 1.5 m high. Two drip irrigation lines, one on either side of the blueberry plant, were placed under a sawdust mulch cover within standard raised beds (Bryla et al. 2011) and provided 255±5 mm H2O per growing season daily at an average rate of 10 mm per day. Four hemp fiber substrates (FIB) with 6 gm of GUM spread on the top were placed in the center of each of two plots on the soil surface at a rate of 124 substrates per hectare directly under the dripline emitter. The distances between the FIB pads and the target bush were 0, 10, 20, 30, 40, 50, and 70 m, in each direction from the target bush. Previous work (Rossi-Stacconi et al. 2020) had indicated a minimal effective range of ˜7 meters for a point source. Four mesh bags were placed in the rows on either side of the FIB at increasing distances from the FIB. Each bag contained 10 previously purchased organic blueberries, washed and inspected before use. Mesh bags were replaced on September 13, 20, 23, 27, 30 and October 4, 9 and 14, and the number of infested berries removed were recorded at each date.

### Example Substrate Based on Food Grade Behavioral Arrestant

Decoy™-SWDM is a food-grade-gum substrate that has a tablet form. It is effective against Drosophila suzukii (SWD). Decoy substrate is available from TerrAmor, Inc. Corvallis, Oregon, USA. It is suitable for use in various settings, including agricultural, commercial, shadehouse, tunnel, nursery, and home use. The following are representative, non-limiting parameters for use of an embodiment of the inventive subject matter:
Active ingredients: Citric acid: 0.01%
Inert ingredients: Animal glue, Cherry, Cellulose pulp, Dextrins, Gelatins: 99.99%
Weight: Each tablet weighs ˜0.06 oz (1.8 g), at a density of ˜0.0725 lbs/sq ft.
The Re-Entry Interval (REI): 0 hours. The Pre-Harvest Interval (PHI): 0 hours. Personal Protective Equipment (PPE) is not required for this product.
Mode Of Action: Decoy tablets protect against egg laying on susceptible fruit. The insect lays its egg in the tablet as opposed to fruit. Sometimes, SWD females can feed or probe on Decoy tablets instead of laying eggs in the fruit. In addition, eggs laid by SWD into Decoy tablets cannot develop because of the tablet's desiccating action on the eggs.
Compatibility: Decoy substrates are compatible with most used insecticides, fungicides and fertilizers.

Use Sites: The product can be used in agricultural and commercial use, shadehouse, tunnel, nursery and home use. It is used to control Spotted-wing drosophila (Drosophila suzukii). Decoy can be used on all susceptible crops including strawberries, blueberries, caneberries, cherries, grapes and additional susceptible fruit.
Personal Protective Equipment: Not required.
User Safety Recommendations: Wash hands before eating, drinking or chewing gum, using tobacco or using the toilet.
Environmental Hazards And Non-Target Impacts: None known
First Aid And Precautions: Store only in original container in a dry place inaccessible to children and pets. Do not reuse empty containers. Avoid contact with eyes, skin or clothing. If in eyes, flush with water for at least 15 minutes. If on skin, wash with plenty of soap and water. Get medical attention if irritation persists.
Storage And Disposal:
   Store in a cool, dry area, away from sunlight or heat source.
   Do not store below 20 and above 86° F. (−6.66 to 30° C.) for extended periods of time.
   Product must be kept away from additional sources of heat. It may be appropriate to enquire whether prevailing or anticipated temperatures may be harmful.
   Flash point is 302° F. (150° C.)
   Product must be protected from excessive humidity and must accordingly be stored under cover.
   Store only in original container in a dry place inaccessible to children and pets. Do not reuse empty containers.
Use Directions: Do not use this product in a manner inconsistent with its labeling. Apply the product at the rate of fifty (50) dispensers per acre (124 dispensers/ha). A minimum of ten (10) dispensers should be used at a time. Do not place single dispensers in isolation, as a general rule. Dispensers should therefore be placed up to approximately 3 feet-40 feet (1 m-12 m) apart, depending on row and plant spacing of the crop. The dispensers need contact with a daily (ideally afternoon) supplemented water source. It is suggested that dispensers should be placed directly below or close to the irrigation source, taking spacing into consideration. Use directions must be followed carefully. It is impossible to eliminate all risks inherently associated with the use of this product. Crop injury, ineffectiveness, or other unintended consequences may result because of uncontrollable factors including, but not limited to: weather conditions; presence of other materials; or the manner of use or application.
Product Description: Decoy is a brownish red solid formulation within a 0.06 oz. (1.8 g) tablet (pH=6.7) in a plastic dispenser. The mixture turns gel-like when getting into contact with water. After water absorption, the product has a slightly musty smell.

### Other Example Substrates

In the following passages, non-limiting, exemplary formulations for controlling SWD are described. These and other formulations are disclosed in more detail in published US Patent Application No. US20210321627, which is hereby incorporated by reference for all purposes.

In a possible embodiment, a substrate for control of Drosophila suzukii is a composition of a plurality of ingredients that serve one or more functions discussed earlier.

One possible composition includes: a cherry-derived component (gelling agent), cellulose pulp (viscosity modulating agent), animal glue (binding agent), Gelatine (Gelling agent), dextrins (Encapsulating and thickening agent), and a humectant (water absorbent).

Cellulose pulp and dextrins are/encapsulated and granulated using a standard granulator/encapsulator using, water, vaporization, combination, and heat. This allows for tighter binding and encapsulation of favorable attributes of the behavioral arrestant that results in increased field longevity and pest management benefits. Formulation can be conducted using standard encapsulating and granulation processes and machines.

In some embodiments, the cellulose pulp is coniferous or non-coniferous tree or plant cellulose pulp. In some embodiments, the cherry-derived component is dried-cherry or fresh cherry and can include cherry exocarp, cherry mesocarp, or a combination thereof.

In some embodiments, the cherry-derived component is included in the composition in an amount of 0.1 wt % to about 99 wt %, 0.5 wt % to 90 wt %, 10 wt % to 90 wt %, %, 40 wt % to 80 wt %, or 50 wt % to 70 wt % on dry weight basis.

In some embodiments, cellulose pulp is included in the composition in an amount of 0.1 wt % to 99 wt %, 5 wt % to 80 wt %, or 10 wt % to 60 wt % on dry weight basis.

In some embodiments, the composition comprises thiamine in an amount of 0.001 wt % to 99 wt %, 0.1 wt % to 50 wt %, or 0.5 wt % to 10 wt % on dry weight basis.

In some embodiments, the humectant is hyaluronic acid, alginic acid, collagen, calcium chloride, egg white, egg yolk, gelatin, glycerol, triacetin, glycerol acetates, lecithin, pyrrolidone carbonic acid, sorbitol, xylitol, mannitol, maltitol, honey, caramelized sucrose, propylene glycol, sodium lactate, glycerin betaine, trehalose, sodium stearoyl lactate, or a combination thereof.

In some embodiments, the composition further includes one or more components selected from collagen, beta-cyclodextrin, carrageenan, agar, calcium acetate, and calcium propionate.

In some embodiments, the composition includes cherry, cellulose pulp, thiamine, hyaluronic acid, collagen, beta-cyclodextrin, carrageenan, agar, calcium acetate, and calcium propionate. These are thickening agents.

In some embodiments, the composition may include dried D. suzukii insect powder as a behavioral arrestant.

In some embodiments, the composition may isopropyl dodecanoate, isopropyl tetradecanoate, 1,2,3-propanetriol triacetate, methyl dodecanoate, methyl tetradecanoate, myristic acid, lauric acid, or a combination thereof. These increase behavioral arrestant action.

In some embodiments, the composition may include a volatile compound component comprising methyl tetradecanoate (methyl myristate), myristic acid, lauric acid, methyl hexadecanoate (methyl palmitate), palmitic acid, palmitoleic acid, and mixtures thereof. In some embodiments, the volatile compound component comprises methyl tetradecanoate, myristic acid, lauric acid, methyl hexadecanoate, palmitic acid, and palmitoleic acid.

In some embodiments, the composition is configured to arrest male and female D. suzukii.

In some embodiments, the composition does not contain a pesticide, e.g., a synthetic compound or other chemical compound that is not consistent with USDA organic labeling and is processed to have biocidal effect on a target lifeform.

In any embodiment expressing numerical range, the embodiment includes the end points of the range and values about or near the end points that are within the scope and spirit of the inventive subject matter as would be appreciated by persons of ordinary skill in the art.

In some embodiments, the substrate is a composition having an aqueous, solid, or a dry powder form. In some embodiments, the composition is a solution, a suspension, a gel, or a gum.

In another aspect, provided herein is a method of controlling D. suzukii, comprising treating an object or an area with an effective amount of a D. suzukii control composition disclosed herein.

In some embodiments, the treated area is a non-fruiting base of a plant, such as a plant member of Vaccinium spp., Rubus spp., Vitis spp., Fragaria spp., or Prunus spp. In some embodiments, the plant is a blueberry plant, huckleberry plant, raspberry plant, blackberry plant, strawberry plant, grape plant, or cherry plant.

In some embodiments of the methods disclosed herein, the treatment results in greater than about 35%, greater than about 40%, greater than about 50%, greater than about 60%, greater than about 70%, or greater than about 75% reduction in D. suzukii egg laying as determined by field oviposition trials on Elliott blueberries.

In another aspect, provided the inventive subject matter is directed to a composition for control of Drosophila suzukii that includes methyl myristate, myristic acid, lauric acid, methyl palmitate, palmitic acid, and palmitoleic acid.

In some embodiments, the composition includes 20 wt % to 65 wt % palmitic acid, 20 wt % to 65 wt % palmitoleic acid, 7 wt % to 25 wt % myristic acid, 0.01 wt % to 1.0 wt % lauric acid, 0.01 wt % to 1.0 wt % methyl palmitate, 0.01 wt % to 1.0 wt % methyl myristate.

In certain embodiments, the composition may include 43.10% palmitic acid, 41.11% palmitoleic acid, 14.74% myristic acid, 0.66% lauric acid, 0.32% methyl palmitate, and about 0.07% methyl myristate by weight or thereabout any such values.

In some embodiments, the composition may include a food grade matrix, e.g., a matrix comprising a cherry-derived component. In some embodiments, the food grade matrix may include cellulose pulp, thiamine, humectant, or a combination thereof. The cherry-derived component may include freeze-cherry or fresh cherry.

In some embodiments, the composition may include cherry, cellulose pulp, thiamine, hyaluronic acid, collagen, beta-cyclodextrin, carrageenan, agar, calcium acetate, and calcium propionate. In certain embodiments, the composition further may include dried D. suzukii powder. In some embodiments, the composition does not contain a pesticide.

In yet another aspect, the inventive subject is directed to a method of controlling D. suzukii, that includes the steps of providing a dispenser as disclosed herein and adding into the dispenser an an effective amount of a D. suzukii control composition disclosed herein. In some embodiments, composition is in the form of a tablet. In some embodiments, the dispenser includes, 2, 3, 4, 5, 6, 7, 8, 9, 10 or more tablets packaged into the dispenser.

Persons skilled in the art will recognize that many modifications and variations are possible in the details, materials, and arrangements of the parts and actions which have been described and illustrated to explain the nature of the inventive subject matter, and that such modifications and variations do not depart from the spirit and scope of the teachings and claims contained therein.

From the teachings herein, persons skilled in the art will appreciate that the inventive subject matter may be used against various pests and for various crops by scaling the size of the dispenser and its openings to a selected pest and by choosing active agents for use in the dispenser that are specific to a selected pest.

Any patent and non-patent literature cited herein is hereby incorporated by references in its entirety for all purposes.

The principles described above about any particular example can be combined with the principles described regarding any one or more of the other examples. The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein but are to be accorded the full scope consistent with the language of the claims, wherein reference to an element in the singular, such as by use of the article “a” or “an” is not intended to mean “one and only one” unless specifically so stated, but rather “one or more”. As used herein, “and/or” means “and” or “or”, as well as “and” and “or.”

All structural and functional equivalents to the elements of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed as “a means plus function” claim under US patent law unless the element is expressly recited using the phrase “means for” or “step for”.

1. A dispenser for supporting a substrate comprising an insect control composition, the dispenser, comprising:
one or more sidewalls extending upwardly from a bottom wall of the dispenser, the one or more sidewalls and bottom wall being configured with a plurality of apertures;
a receptacle disposed in a space defined by the one or more sidewalls and the bottom wall for supporting the substrate;
means for coupling the dispenser to the irrigation line, a plant, or other another object that is sized and shaped to receive a section of an irrigation line so that one or more apertures in the irrigation line direct water onto the substrate disposed on the receptacle, the coupling means receiving the irrigation line having an opening size to accommodate irrigation line having a diameter of from 2 cm-10 cm, the coupling means at least one sidewall aperture orienting the irrigation line above the receptacle; and
wherein at least one aperture, other than the irrigation line opening, is disposed in a sidewall, bottom wall or in a lid for the dispenser and is sized and shaped to allow ingress of a target insect;
wherein at least one aperture disposed in a sidewall or bottom wall is a drainage aperture that is positioned to drain water so that water does not stand at or above the level of the receptacle; and
wherein each of the dispenser's height, width, and depth dimensions is between 1 cm to 30 cm.

2. The dispenser of claim 1 wherein the entire receptacle is at a bottom portion of the dispenser and surrounded by upwardly extending walls.

3.-7. (canceled)

8. The dispenser of claim 1 herein further comprising the substrate, the substrate comprising a composition that is an active agent for management or control of the target insect type.

9. (canceled)

10. A dispenser system for pest management, comprising:
a dispenser, comprising:
one or more sidewalls extending upwardly from a bottom wall of the dispenser,
wherein at least one aperture is disposed in one of the walls that is sized and shaped to allow ingress of a target insect type;
a receptacle for supporting a substrate disposed in a space defined by the one or more sidewalls and the bottom wall;
a substrate comprising a composition that is an active agent for management or control of the target insect type; and
wherein each of the dispenser's height, width, and depth dimensions is between 1 cm to 30 cm.

11.-16. (canceled)

17. A method of insect control comprising providing a plurality of dispensers according to claim 1 and spacing them about a plurality of plants; providing a substrate for insect control in each dispenser; and allowing for the dispenser to attract a target insect.

18. The method of claim 17 further comprising coupling the dispensers to irrigation line(s) associated with the plants.

19.-23. (canceled)

24. A method of pest control or management, comprising:
providing a plurality of dispenser systems for pest management, each dispenser comprising:
a dispenser, comprising:
one or more sidewalls extending upwardly from a bottom wall of the dispenser,
wherein at least one aperture is disposed in one or more of the walls that is sized and shaped to allow ingress of a target insect type;
a receptacle for supporting a substrate disposed in a space defined by the one or more sidewalls and the bottom wall;
the substrate comprising a composition that is an active agent for management or control of the target insect type;
wherein each of the dispenser's height, width, and depth dimensions is between 1 cm to 30 cm; and
placing the dispenser system in a site comprising a plurality of plants susceptible to the target insect.

25. The method of claim 24 where the site comprises a plurality of fruit plants.

26. The method of claim 25 wherein the target insect is a fruit fly species.

27. (canceled)

28. The method of claim 24 wherein the dispensers are provided at a rate of at least 20 dispensers per hectare with generally uniform spacing of plants and dispensers.

29. (canceled)

30. The method of claim 24 wherein a minimum of ten (10) dispensers are used and are spaced up to 13.33 m apart from each other among the plants.

31. The method of claim 24 wherein method comprises periodically hydrating the substrate in the dispenser.

32. The method of claim 24 wherein each dispenser is coupled to an irrigation line, the irrigation line having apertures for and being oriented relative to the dispenser so that fluid can be directed into the dispenser and wet the substrate.

33. The method of claim 30 wherein the irrigation line is also associated with the susceptible plants and is the irrigation line for the plants.

34. The method of claim 24 wherein the substrate comprises a composition that serves as an attractant, behavioral arrestants, developmental arrestants, deterrent, and/or stimulant that is active against the target insect.

35. The method of claim 24 wherein the substrate comprises a semiochemical that induces ovipositioning in the target insect.

36. The method of claim 25 wherein the fruit plants are blueberry, raspberry, blackberry, other berry crop plants or cherry plants (trees) or grape plants.

37.-46. (canceled)

47. A dispenser, comprising:
a container structure having a bottom surface and upwardly surrounding walls disposed around the perimeter of the bottom surface, the dispenser having a height of 4 to 30 cm and width (or diameter) of 4 to 30 cm;
a receptacle at the bottom portion of the dispenser for supporting a replaceable substrate;
an aperture for depositing the substrate on the receptacle area;
a hook disposed on a top portion of the dispenser with an opening configured to receive an irrigation line and to suspend the dispenser therefrom;
a staking aperture for receiving a stake usable to anchor the dispenser to a base surface; and
a plurality of drainage and/or target insect ingress apertures disposed on the sidewalls.

48. The dispenser of claim 47 wherein the hook is integral with the dispenser.

49. The dispenser of claim 47 wherein the stake aperture is at the top of the dispenser and a second staking aperture is in an aligned opposed position at the bottom of the dispenser so that a stake can be placed through the dispenser into the base surface, the stake being oriented vertically when placed into the staking apertures.

50. The dispenser of claim 47 wherein the dispenser has a round cross section.

51. The dispenser of claim 47 wherein there are at least 10 or more drainage and/or insect ingress apertures in the sidewalls.

52. The dispenser of claim 51 wherein the drainage and/or insect ingress apertures are 4-6 mm wide (or diameter).

53. The dispenser of claim 47 wherein the dispenser's exterior is red.

54. The dispenser of claim 47 wherein the receptacle has a surface area of 3 cm²-60 cm².

55. The dispenser of claim 47 wherein Irrigation line aperture is 2-10 cm².
